(19) United States
(12) Patent Application Publication
(10) Pub. No.: US 2006/0083288 A1
(43) Pub. Date: Apr. 20, 2006

(54) Arrangement for monitoring local temperatures

(76) Inventors: Richard Riedel, (US); Rainer Lang, (US); Rainer Huscher, (US); Otto Nachbauer, (US)

Correspondence Address: SOFER & HAROUN, LLP, Suite 910, 317 Madison Avenue, New York, NY, 10017, US

(21) Appl. No.: 11/207,988

(22) Filed: Aug. 18, 2005

(30) Foreign Application Priority Data
Sep. 17, 2004 (DE) 10 2004 045 354.3

(51) Int. Cl. G01K 1/14; G01K 13/00

(52) U.S. Cl. 374/141

(57) ABSTRACT

An arrangement for monitoring local temperatures in the area of heat generators is provided, in which a temperature sensor (7), the resistance of which is temperature-dependent, is connected by electrical leads (9, 10) to a voltage source. A capacitor (8) is connected to the leads (9, 10) electrically in parallel to the temperature sensor (7), and the temperature sensor (7) and the capacitor (8) are embedded jointly as a one-piece component in the insulating material (11).

### RELATED APPLICATION

This application is related to and claims the benefit of priority from German Patent Application No. 10 2004 045 354.3, filed on Sep. 17, 2004, the entirety of which is incorporated herein by reference.

### FIELD OF THE INVENTION

The invention pertains to an arrangement for monitoring the temperature in the area of heat generators, where a temperature sensor, the electrical resistance of which is temperature-dependent and which is embedded in an insulating material, is connected by electrical leads to a voltage source.

### BACKGROUND OF THE INVENTION

An arrangement of this type is used, for example, wherever it must be ensured that excessive temperatures never occur at predetermined points of machines and appliances with heat generators. If such temperatures do occur, it is then possible to provide for cooling, or the heat source in question can be turned off at least temporarily. According to the conventional technology, an NTC (negative temperature coefficient) resistor, also called a hot wire, is used, which has two electrical leads and is connected to a control unit, from which it obtains its power supply. The control unit is connected in turn to a voltage source. The temperature sensor, referred to below as the “NTC”, is embedded for protection in an insulating material such as an epoxy resin. An NTC is a temperature-dependent electrical resistor, the resistance of which decreases as the temperature increases. The resistance value can be monitored by means of an electronic evaluation circuit installed in the control unit, by means of which measures for lowering the temperature can be initiated if necessary.

One area of application for these arrangements is motor vehicles. Points at which an NTC can be used to monitor the temperature are in the area of the engine, on compressors for pneumatic springs, and near the transmission oil. The arrangements with an NTC which are obtainable commercially and in actual use generally operate in a satisfactory manner. It can happen, however, that, as a result of external electromagnetic fields, electrical voltages can be induced in the leads which connect the NTC to the evaluation circuit. Stray currents can therefore be generated in the leads, so that the NTC in question is heated not only by its environment but also by the effect these currents. The measurement result is thus falsified, because the resistance of the NTC is lowered to a value which does not correspond to the ambient temperature.

### OBJECTS AND SUMMARY OF THE INVENTION

The invention is based on the task of designing the arrangement described above in such a way that external electromagnetic fields cannot have any effect on the measurement result of the NTC.

This task is accomplished according to the invention in that:
a capacitor is connected to the leads electrically in parallel to the NTC; and
the NTC and the capacitor are embedded jointly, as a one-piece component, in the insulating material.

As a result of the capacitor, which acts as a short-circuit with respect to alternating currents, the NTC is protected from currents which are generated by induction in its leads. Its supply of direct current from the evaluation circuit remains unchanged and intact. External electromagnetic fields can therefore no longer falsify the measurement result. That the NTC and the capacitor are embedded jointly in the insulating material is an especially advantageous feature of this arrangement, because a one-piece component is obtained. There are therefore no problems with the installation of the component, the size of which is increased only slightly by the capacitor in comparison with a component consisting of an NTC alone, because the component can be positioned in exactly the same way as the conventional sensor consisting just of an NTC. The two leads project out of the insulating material in the same way as before and are used to connect the component to the evaluation circuit in the same way. This significant advantage of the arrangement also makes it possible to replace an old NTC with the new component without the need for any additional measures.

### BRIEF DESCRIPTION OF THE DRAWINGS

An exemplary embodiment of the object of the invention is illustrated in the drawings:

FIG. 1 shows a schematic diagram of a device with an arrangement according to the invention installed therein;

FIG. 2 shows a circuit diagram of the arrangement; and

FIG. 3 shows an enlarged view of the arrangement as it would appear in space.

### DETAILED DESCRIPTION

The temperature sensor used in the arrangement is referred to below as the “NTC”. This term is intended to include any temperature sensor which can be used for the purposes of the invention. The special area of application is automotive, although this should be considered merely representative for all other possible areas.

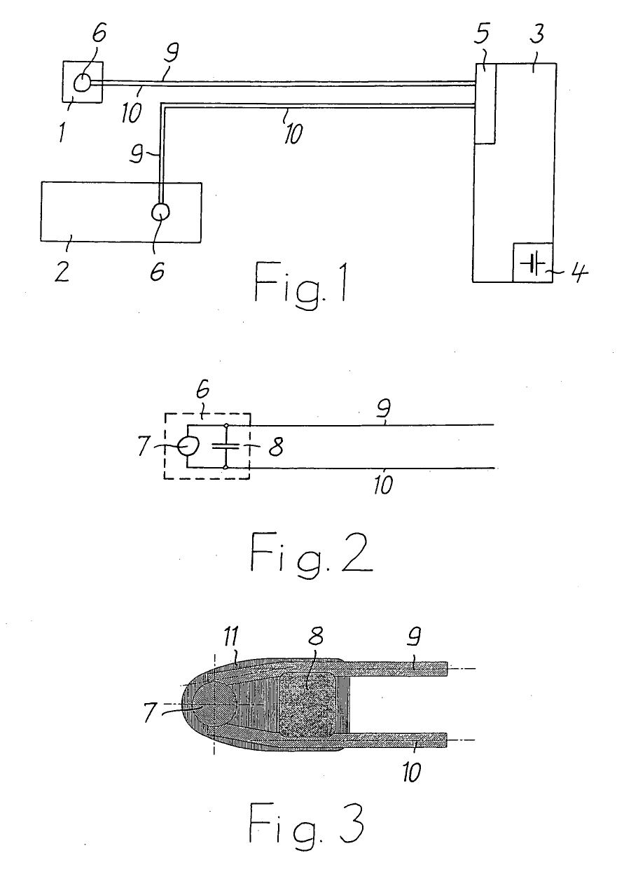

FIG. 1 shows a schematic diagram of the parts of a motor vehicle in the form of boxes. For example, a compressor 1 for a pneumatic spring and an engine 2 are shown. The vehicle also has a control unit 3, which is connected to a voltage source 4, which will usually be the battery of the vehicle. An evaluation circuit 5 is installed in the control unit 3.

Both in the area of the compressor 1 and in the area of the engine 2 there is at least one component 6 installed to monitor the temperature. This component comprises an NTC 7 and a capacitor 8 (FIGS. 2 and 3). Each component 6 is connected by two electrical leads 9 and 10 to the evaluation circuit 5. The capacitor 8 is connected electrically in parallel to the NTC 7, as shown in FIG. 2. Alternating currents flowing in the leads 9 and 10, caused by external electromagnetic fields, do not affect the NTC 7. They are short-circuited by the capacitor 8.

NTC 7 and capacitor 8 are located as close together as possible in space and are embedded in insulating material 11. A suitable insulating material is an epoxy resin, for example, which is also a good heat insulator. The insulating material 11 gives the unit 6 sufficient mechanical stability, and it protects the NTC 7 and the capacitor 8 from mechanical loads as well. The component 6 can also be coated with a silicone resin. It is an easy-to-handle part, which can be installed wherever it is needed. After it has been installed, the component 6 is connected by its leads 9 and 10 to the electronic evaluation circuit 5.

1. An arrangement for monitoring local temperatures in the area of heat generators comprising:
a temperature sensor connected by electrical leads to a voltage source, where the electrical resistance of the sensor is temperature-dependent and the sensor is embedded in insulating material, wherein a capacitor is connected to the leads electrically in parallel to the temperature sensor; and in that the temperature sensor and the capacitor are embedded jointly as a one-piece component in the insulating material.
